(19) United States
(12) Patent Application Publication
(10) Pub. No.: US 2004/0140963 A1
(43) Pub. Date: Jul. 22, 2004

(54) Stylus having variable reflectivity and method for data input therewith

(76) Inventors: David Kim, Santa Clara, CA (US); Mark Wiltse, Redwood City, CA (US)

Correspondence Address: Karl M. Steins, Steins & Associates, Suite 120, 2333 Camino del Rio South, San Diego, CA, 92108, US

(21) Appl. No.: 10/640,797

(22) Filed: Aug. 14, 2003

Related U.S. Application Data
(63) Continuation of application No. 10/438,110, filed on May 13, 2003.
(60) Provisional application No. 60/441,269, filed on Jan. 21, 2003.

(51) Int. Cl. G09G 5/00

(52) U.S. Cl. 345/179

(57) ABSTRACT

A Stylus Having Variable Reflectivity and Method for Data Input Therewith is disclosed. The stylus has a reflective portion attached to it that will reflect incident light in response to user actuation. The system with which the stylus is configured to cooperate will receive reflected incident light and interpret it as a “mouse click” special data input. The user actuation can be provided in a variety of different fashions, depending upon the configuration of the particular stylus, including tip-touch-activated, as well as touching a pad disposed on the body of the stylus. The responsively reflective portion is locatable at the tip of the stylus or at other locations on the body of the stylus.

This application is a continuation of non-provisional application Ser. No. 10/438,110, filed May 13, 2003, and provisional application Serial No. 60/441,269 filed Jan. 21, 2002, now pending.

### BACKGROUND OF THE INVENTION

1. Field of the Invention

This invention relates generally to input systems for computing devices and, more specifically, to a Stylus Having Variable Reflectivity and Method for Data Input Therewith.

2. Description of Related Art

The world of mobile computing has expanded dramatically with the evolution of notebook computers and personal digital assistance (PDA's) and their ability to now provide more functionality and information, and therefore productivity to users when they are away from their home or office. In fact, many users have replaced their desktop computers with notebook computers, having actually increased their available computing power in doing so. Although PDA's have also evolved, their input/output limitations (mainly due to display size constraints) have substantially limited their functionality. The strength of the PDA is its extremely compact and convenient size; the strength of the notebook is its power. The problem is that the power applications are coupled with ergonomic size constraints, making even the notebook computer too large to be truly convenient as a mobile device, while the I/O limitations of the PDA have prevented it from becoming a replacement for a PC or notebook computer.

Several approaches to handheld, portable power computing have emerged, but all with significant tradeoffs to the user. Pans that record and later download what was written into software are small, but limited. Handheld projectors using LED sources can project simple, fixed images, but no motion or interaction. Projection eyewear is an alternative for military or hospital applications, but distractive and unproven in the mainstream.

In the course of developing the versatile, powerful projection image computing device and system that is the subject of the parent patent application to the instant application, a variety of technical issues arose—one of which relates to the method for the user to interact with the projected image display. What is needed is a device and method of providing a user with intuitive and reliable interaction with a projected display and associated input subsystem so that the user can make inputs to the computing device without the need for a separate keyboard or other input device.

### SUMMARY OF THE INVENTION

In light of the aforementioned problems associated with the prior devices and methods, it is an object of the present invention to provide a Stylus Having Variable Reflectivity and Method for Data Input Therewith. The stylus should have a reflective portion attached to it that will reflect incident light in response to user actuation. The system with which the stylus is configured to cooperate should receive reflected incident light and interpret it as a “mouse click” special data input. The user actuation should be provided in a variety of different fashions, depending upon the configuration of the particular stylus, including tip-touch-activated, as well as touching a pad disposed on the body of the stylus. The responsively reflective portion should be locatable at the tip of the stylus or at other locations on the body of the stylus.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of one embodiment of a computing system and device having interactive projected display;

FIG. 2 is a close-up perspective view of the device of FIG. 1;

FIG. 3 is a depiction of the functional components of the output portion of the device of FIGS. 1-2;

FIG. 4 is a perspective view of a reflective stylus of the present invention;

FIG. 5 is a perspective view depicting how the stylus of FIG. 4 interacts with the device of FIGS. 1-3;

FIG. 6 is a partial cutaway perspective view of the tip area of a tip-actuated embodiment of the stylus of the present invention; and

FIG. 7 is a perspective view of a button-actuated stylus of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Stylus Having Variable Reflectivity and Method for Data Input Therewith.

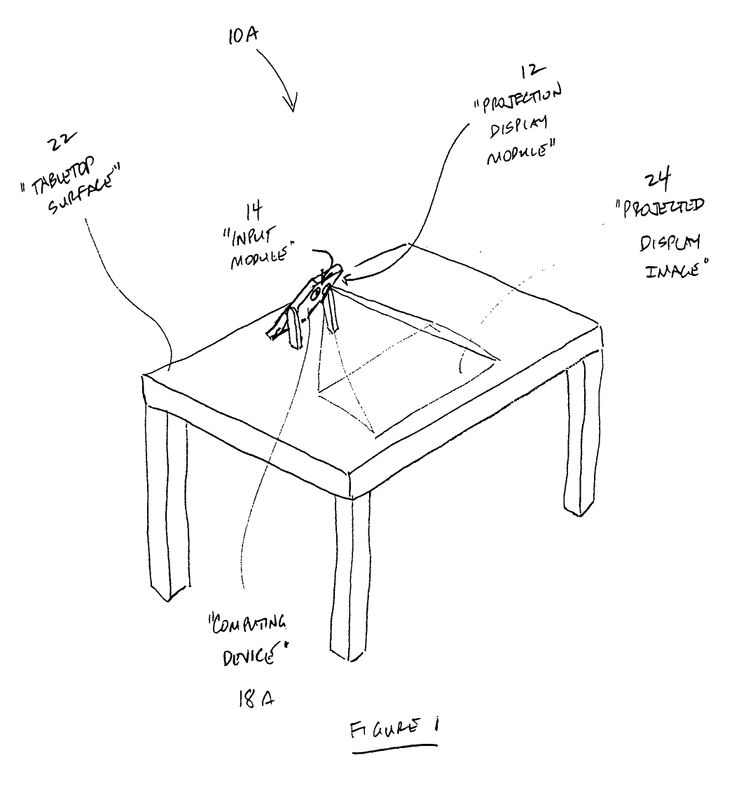

The present invention can best be understood by initial consideration of FIG. 1. FIG. 1 is a perspective view of one embodiment of a computing system and device having interactive projected display. In this embodiment of the device 10A, the computing device 18A has a projection input/output system incorporated within it. The device 10A here is a modified palm-sized PDA computing device 18A. The device 10A is configured to rest on a horizontal surface, such as the tabletop 22 shown, in an orientation that allows the projection display module 12 to project a display image 24 onto the surface 22. As will be discussed further below, the input module 14 is positioned within the device 10A such that it can view the projected display image 24 and receive input commands for operating the computing device 18A by user interaction with the actual display image 24 itself. It should be appreciated that the display image 24 can be projected on a flat surface having any orientation, and that it is not limited to horizontally oriented surfaces.

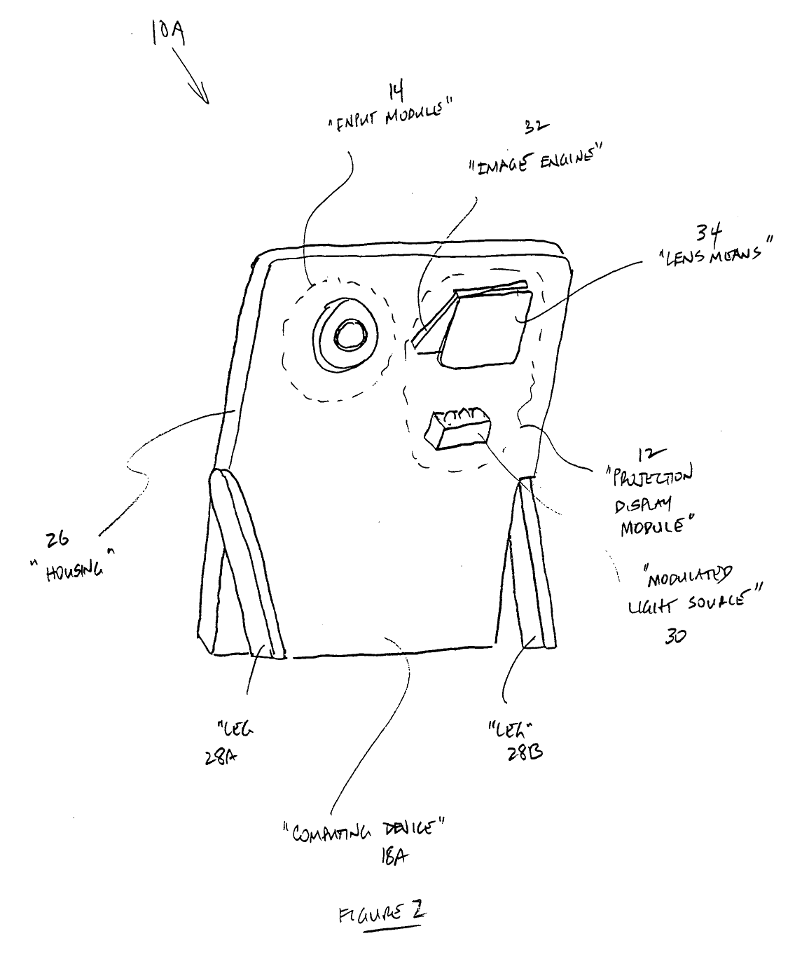

FIG. 2 is a close-up perspective view of the device 10A of FIG. 1. The device 10A has a palm-sized housing 26 and a pair of retractable legs 28A and 28B. The legs 28 are designed to provide the desired cant to the device 10A such that the projection display module 12 and input module 14 are aimed at the horizontal surface upon which the device 10A is resting. These legs 28 can be retracted by simply folding them back into pockets formed in the housing 26 in order to provide a very smooth and condensed package for ease and comfort in carrying. Of course, this is only one example of a device and method of deploying the projected display module 12 and input module 14. Many other concepts are possible, such as a swing arm, a flip-out hinged array, and a calibrated foot might be used with the device of the present invention.

Although not shown here, essentially the rest of the computing device 18A is identical to a conventional PDA, such that a user might also be able to interact with the conventional PDA in those circumstances where a projected display and associated input method are not desired.

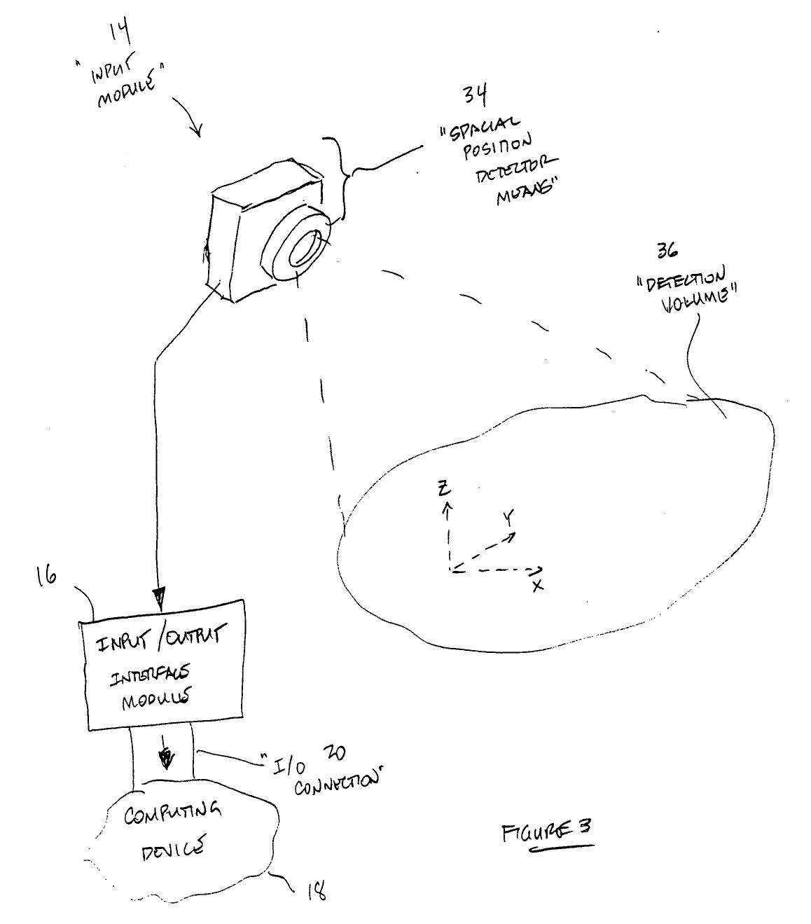

FIG. 3 is a depiction of the functional components of the output portion of the device of FIGS. 1-2. The input module 14 of this embodiment comprises a special position detector means, such as either a CMOS camera or a CCD camera that has the ability to observe the activity occurring within its view. In particular, the camera would determine where, in a spacial sense, the user has touched the displayed image; the input module 14 takes the observed position and delivers it to the I/O interface module for conversion into a format for use by the computing device as a pointer input. Use of a CMOS or CCD camera for visually conducting surveillance on the detection volume 36 enables the system to detect movement and position in three axes. The detection in three axes provides the system with both movement and position with substantial accuracy; as such, the user's desired input commands can be more reliably interpreted. Furthermore, the camera may be used to provide the projection display module with feedback in order to fine tune the displayed image based on actual detected image quality.

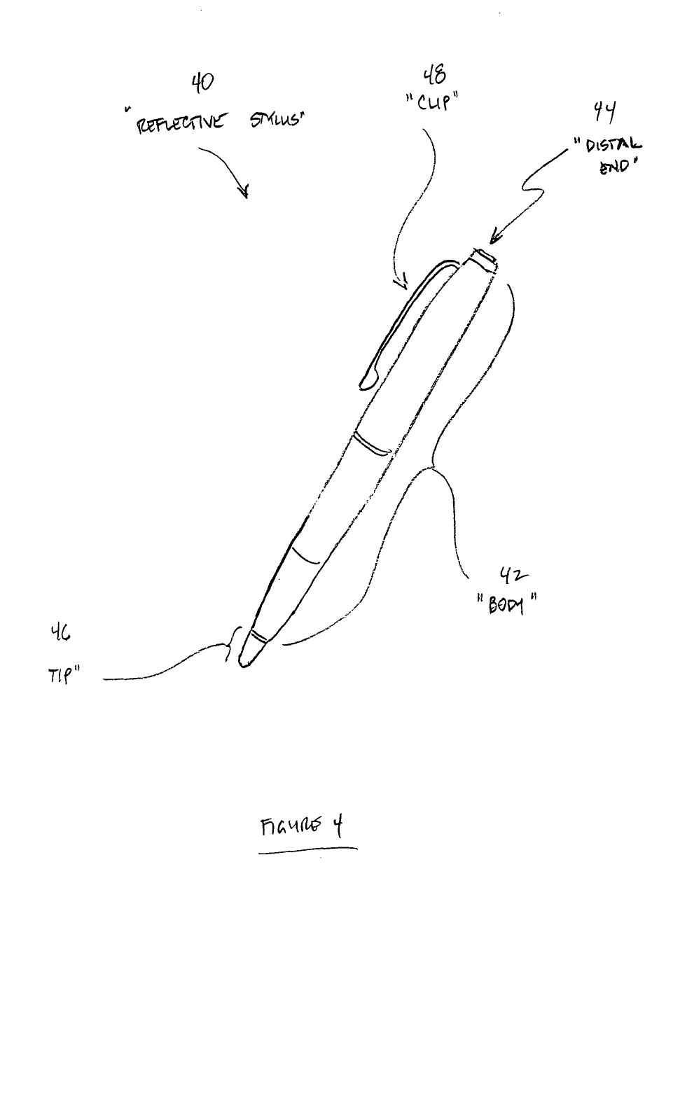

In other versions, a position detector having less capability than those previously described may be employed, an example being 2-dimensional detection plus input from a modulated stylus or pointer, such as a device for detecting the location of the tip and/or orientation of a specialized stylus or pointer being used by the user to enter commands and other inputs. Having now reviewed a device that is suited to operate with the present invention, we shall turn to FIG. 4 to begin discussing it.

FIG. 4 is a perspective view of a reflective stylus 40 of the present invention. This embodiment of the stylus 40 is defined by a body 42 having a distal end 44 and a tip 46, and a clip 48 extending therefrom. Other shapes and sizes for the stylus 40 are conceived; this version is simply being presented in order to provide ease of understanding.

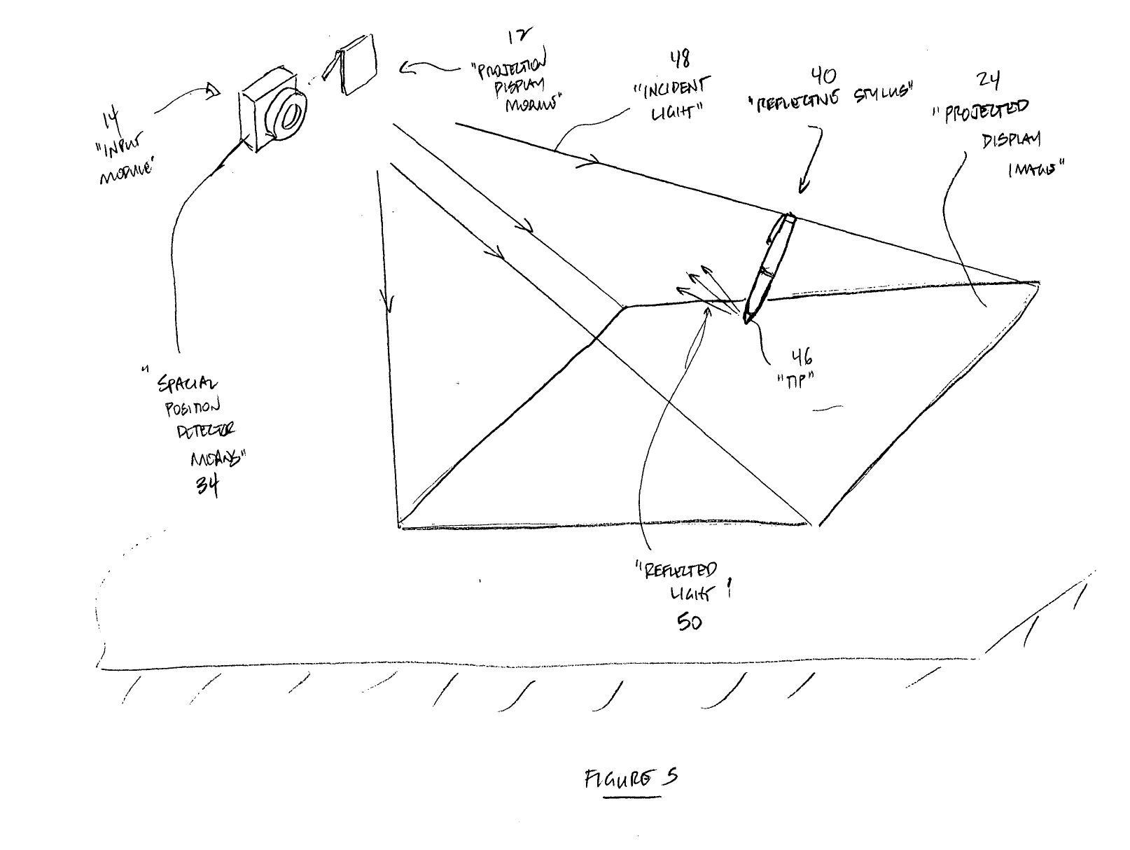

By its name, it should be apparent that the stylus 40 includes a reflective aspect; the reflectivity of the device is operated and/or triggered by the user as a way to provide an input/interaction with the projected display device described above in FIGS. 1-3. As will be discussed more fully below in connection with other drawing figures, the tip 46 (typically) will be able to selectively reflect incident light—the reflection of light is detectable by the projected display device, including it's spacial orientation related to the projected display, in order to provide what is interpreted as an input command to the software program operating within the projected display device. FIG. 5 provides additional specificity of this operability.

FIG. 5 is a perspective view depicting how the reflective stylus 40 of FIG. 4 interacts with the device of FIGS. 1-3. As discussed above, the projected display device has a projection display module 12 for displaying a projected display image 24 onto a substantially flat surface. The image 24 is, essentially, what would conventionally be displayed on a computer monitor, namely that display generated by the software program and/or operating system of the projected display device.

The projected display image 24 is created by the projection display module 12 via incident light (controlled by the module 12) being projected towards the flat surface. The reflective stylus 40 of the present invention can be placed in the path of the incident light 48 and then actuated in such a way as to reflect a portion of the incident light 48. The reflected light 50 is detectable by the spacial position detector means 34 (as discussed above), which sends the event data (i.e. the event is the detection of reflected light 50) to other components of the input module 14 for conversion into an input command to the software program running on the projected display device.

The system may use the normal incident light 48 used for creating the projected display image 24 to generate its detectable reflected light 50 signal; this would be suitable in many cases. In other versions, the projection display module 12 may include a light component that is not visible to the human eye (and therefore does not effect the image 24 quality), such as infrared light. In fact, a dedicated infrared lamp or lamps may be used to create an incident light 48 signal solely for the purpose of interacting with the stylus 40. The benefit of the invisible light approach is that there is little risk of interference or noise from accidental reflection of incident light (e.g. from a projection surface that is parallel to the detector 34), or the inadvertent receipt of light signals from a source other than the projection display module 12.

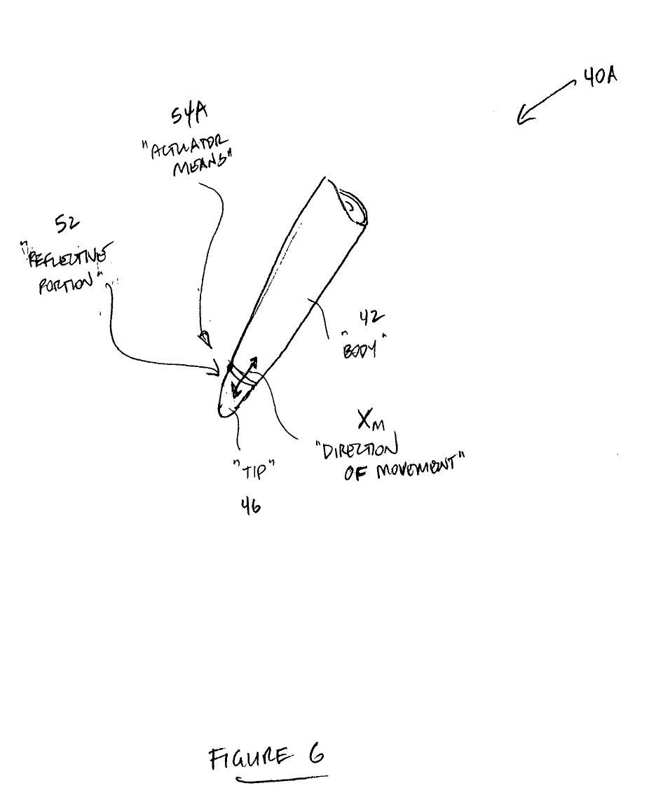

The spacial position detector means 34 is capable of determining the spacial position of the reflective portion of the stylus 40 and then providing this data to the input module 14 for conversion into a position that is relative/oriented to the projected display 24. It should be apparent that this operation will provide functionality very similar to a conventional mouse or trackball (i.e. devices used to interface with conventional computer displays). As such, it would typically be the tip 46 that provides the controllable reflectivity, since it is this portion of the stylus that would intuitively be used by the user to interact with the display image 24. Now turning to FIG. 6, we can continue to discuss the features of the present invention.

FIG. 6 is a partial cutaway perspective view of the tip area of a tip-actuated embodiment 40A of the stylus of the present invention.

The stylus 40A includes a tip 46 that is mechanically connected to the body 42 of the stylus 40A, such that when it is touched or pressed onto a surface, it will move (slightly) in the direction of movement denoted by arrow Xm. When the tip 46 moves a specified distance upwardly (due to downward pressure on the body 42), the actuator means 54A incorporated within the tip 46 and body 42 will cause the reflective portion 52 of the tip 46 to change from being non-reflective to being reflective. When the tip 46 (which is spring loaded to extend downwardly) is allowed to return to its normal non-depressed state, the actuator means 54A will cause the reflective portion 52 to return to being non-reflective.

In operation, then, when the user pushes down on the tip 46, the incident light (see FIG. 5) will be reflected off of the reflective portion 52 of the tip 46. The reflected light (see FIG. 5) will appear to the spacial position detector means (see FIG. 5) as emanating from the tip 46 at its current location (i.e. where the tip 46 has been pushed down). If the user slides the stylus 40A while keeping the tip 46 in a depressed state, the spacial position detector means (see FIG. 5) will detect what is conventionally known as a “dragging” action from the “mouse.” It should be noted that because there is no actual light source within the stylus 40A, there is no need for batteries to power the stylus 40A.

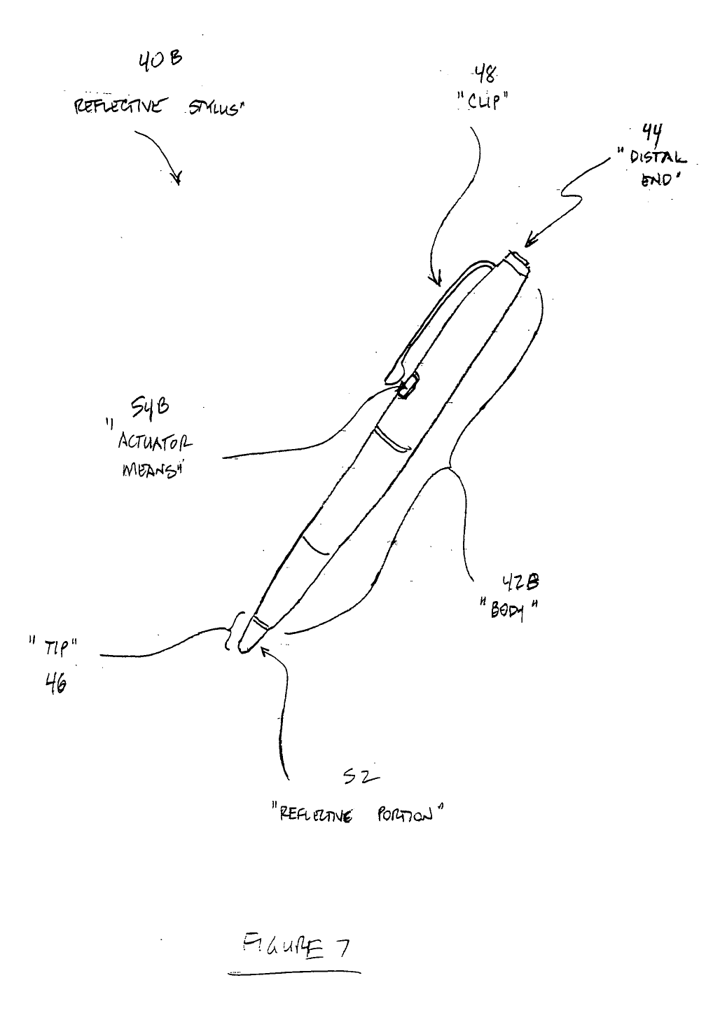

In an alternate design that is not depicted, the actuator means 54A and reflective portion 52 could both be parts of an electronic circuit that electrically translates a depression of the tip 46 into the reflective portion 52 becoming reflective (and vice versa). If we now turn to FIG. 7, we can review another embodiment of the present invention.

FIG. 7 is a perspective view of a button-actuated stylus embodiment 40B. While the device 40 has been called a stylus throughout this disclosure, it is expected that the stylus could be incorporated into a writing implement such as a pen or pencil. Where there is a mechanical pencil or pen incorporated within the stylus 40, it would not be feasible to make the reflectivity of the stylus 40 tip-activated as discussed above in connection with FIG. 6. For these combination implements, it may be more effective to have the actuator means 54B be a button or touch-sensitive pad located elsewhere on the body 42B of the stylus 40. In this embodiment 40B, the actuator means 54B is a pad or button positioned below the tip of the clip 48. The user activates the reflective portion 52 by pressing and releasing the clip 48 so that it's tip touches/depresses and is released from touching/depressing the actuator means 54B. The actuator means 54B here is a electronic circuit that electrically causes the reflective portion 52 (located at the tip 46) of the stylus 40B to become reflective. In other designs, the actuator means 54B may be provided in a different location (e.g. a depressable distal end 44), depending upon the overall design of the stylus 40.

Other versions may combine the functionality of the embodiments pictured in both FIGS. 6 and 7, for example, pressing the tip may actuate a reflective portion at the tip of the stylus, while pressing another pad/button may activate a reflective portion (or a light) located at another portion of the stylus 40. In this manner, the input module of the projected display device may assign different functionality to the two different light sources.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A stylus, comprising:
a body;
a reflective portion attached to said stylus; and
actuator means for actuating said reflective portion attached to said body;
whereby said reflective portion is selectively reflective or non-reflective responsive to said actuator means.

2. The stylus of claim 1, wherein said actuator means comprises a touch-activated pad that is disposed on said body.

3. The stylus of claim 2, wherein touching said touch-activated pad with sufficient force causes said reflective portion to become reflective and not touching said touch-activated pad with sufficient force causes said reflective portion to become non-reflective.

4. The stylus of claim 1, wherein said body is defined by a tip end and a distal end opposite said tip end, said stylus further comprising a tip extending from said tip end.

5. The stylus of claim 4, wherein said reflective portion is disposed on said tip.

6. The stylus of claim 5, wherein said tip is movable relative to said body and said actuator means is responsive to said movement.

7. The stylus of claim 6, wherein said body is defined by a longitudinal axis and said tip is movable along said longitudinal axis.

8. The stylus of claim 7, wherein said tip is movable to a first position and a second position along said longitudinal axis; and
said reflective portion is reflective responsive to said actuator means when said tip is in said first position and said reflective portion is non-reflective responsive to said actuator means when said tip is in said second position.

9. A method for providing user input to a programmable computer, said programmable computer comprising a projected display image and a spacial position detector, the method comprising the steps of:
projecting incident light;
reflecting said incident light, said reflecting comprising selectively reflecting said incident light off of a reflective portion disposed on a stylus; and
detecting said reflected light with said spacial position detector.

10. The method of claim 9, wherein said stylus of said reflecting comprises a body that is further defined by a tip end and a distal end opposite said tip end, said stylus further comprising a tip extending from said tip end.

11. The method of claim 10, wherein said reflective portion of said reflecting is disposed on said tip.

12. The method of claim 11, wherein said tip of said reflecting is movable relative to said body and said stylus further comprises an actuator means that is responsive to said movement.

13. The method of claim 12, wherein said body of said reflecting is defined by a longitudinal axis and said tip is movable along said longitudinal axis.

14. The method of claim 13, wherein said tip of said reflecting is movable to a first position and a second position along said longitudinal axis; and
said reflective portion is reflective responsive to said actuator means when said tip is in said first position and said reflective portion is non-reflective responsive to said actuator means when said tip is in said second position.

15. A stylus comprising:
an elongated body;
a tip extending from said body;
a selectively reflective portion disposed on said tip; and
actuating means for actuating said reflective portion.

16. The stylus of claim 15, further comprising an ink pen extendable from said body.

17. The stylus of claim 15, further comprising a pencil extendable from said body.

18. The stylus of claim 15, wherein:
said stylus defines a longitudinal axis;
said tip is movable along said stylus axis; and
said actuating means is responsive to said tip moving along said stylus axis.

19. The stylus of claim 15, wherein said actuating means comprises a touch-sensitive portion disposed on said body.
